(19) United States
(12) Patent Application Publication
(10) Pub. No.: US 2013/0032120 A1
(43) Pub. Date: Feb. 7, 2013

(54) Piston For Internal Combustion Engine And Method

(71) Applicants: Aaron Claver, Congerville, IL (US); Jeffrey P. Buening, Dunlap, IL (US); Dereck G. Heffron, Peoria, IL (US)

(72) Inventors: Aaron Claver, Congerville, IL (US); Jeffrey P. Buening, Dunlap, IL (US); Dereck G. Heffron, Peoria, IL (US)

(73) Assignee: CATERPILLAR, INC., Peoria, IL (US)

(21) Appl. No.: 13/556,610

(22) Filed: Jul. 24, 2012

Related U.S. Application Data
(60) Provisional application No. 61/515,090, filed on Aug. 4, 2011.

(51) Int. Cl. F02F 3/00; B23P 15/10

(52) U.S. Cl. 123/193.6; 29/888.07; 29/888.074

(57) ABSTRACT

A piston for an internal combustion engine includes a one-piece aluminum piston body including a piston head and a piston skirt adjoining the head. The skirt includes a taper narrowing towards the head and defining a major diameter in a first direction normal to a longitudinal piston axis, and a minor diameter in a direction normal to the first direction. The major diameter and minor diameter may have dimensions specified in Table 1, such that scuffing or scratching of the piston is prevented, particularly during engine break-in.

### RELATION TO OTHER PATENT APPLICATION

This application claims priority to provisional patent application 61/515,090, filed Aug. 4, 2011 with the same title.

### TECHNICAL FIELD

The present disclosure relates generally to pistons for internal combustion engines, and relates more particularly to a tapered piston skirt profile.

### BACKGROUND

A great many different piston designs have been used in internal combustion engines over the years. Engineers have experimented with different geometries, materials and dimensions in the furtherance of many different goals. Among these goals are the control over properties of the combustion process such as the generation of certain emissions. Purposes of experimentation in piston design have also related to engine power to weight ratio, cost, durability, lubrication, cooling, and a host of others. The diversity of shapes, sizes, manufacturing techniques, and material compositions of pistons in the marketplace today is a reflection of the numerous and often competing concerns which have driven internal combustion engine research and development for well over a century. Any given piston is typically the result of many hours of engineering research, balancing numerous cross-coupled variables, so that the piston will have a high probability of performing as desired, often in an operating environment unique to a particular type of engine or specific manufacturer.

In the case of compression ignition internal combustion engines, pistons and their associated hardware such as piston rings, wrist pins and piston rods are typically designed to withstand relatively harsh operating conditions, including temperatures of at least several hundred degrees Celsius and high in-cylinder pressures, as well as other sources of mechanical stress and strain and material fatigue. Housings for such engines are likewise typically designed to be quite robust. Replaceable cylinder liners are commonly used to enable the engine to be rebuilt or remanufactured numerous times at service intervals of many thousands of hours and/or hundreds of thousands of highway miles. The combination of an aluminum piston with a cast iron cylinder liner has been shown to be one advantageous strategy for certain compression ignition engines used in both on-highway and off-highway machines, and in stationary applications such as power generation.

When a new internal combustion engine is placed in service, or returned to service after remanufacturing, the engine may perform acceptably but not precisely as intended. An initial operating period known as “breaking in” the engine typically resolves a variety of minor issues through wear, loosening, deformation, polishing, or other patterns of change in the materials and components of an engine. Despite best efforts, engines do not always break in exactly as desired, and servicing may be required to tailor engine performance for further operation in an optimal manner. The reasons for differences in break-in success even among seemingly identical engines, as well as differences in overall performance can be very difficult to deduce. By way of example, engineers and technicians have noted for literally decades that scuffing, scratching and the like may sometimes occur on an aluminum piston during breaking in the engine, but have failed to determine the root cause, much less offer viable preemptive solutions. As a result, scratched and/or scuffed pistons inevitably occur from time to time, and are often replaced or laboriously serviced, requiring the engine to be idled for unplanned servicing.

Engineers have long known that tightly specifying certain manufacturing parameters can reduce unpredictability and variability in performance among machine systems, such as engines. It is also common practice to employ sound theoretical and experimental bases for relative and absolute sizing of components in machine systems. One strategy for determining an optimal piston size, for the apparent purpose of making a piston and cylinder bore clearance as small as possible via experimentation is taught in U.S. Pat. No. 5,537,970 to Hart. In Hart, an apparatus for determining optimum outer dimensions of a piston employs rod members positionable in a specialized apparatus which, undergo abrasion when a piston is reciprocated against the rods within an engine. It appears that radial locations of each rod end can thus be used to define an optimum peripheral dimension for the piston with respect to a given engine cylinder. While Hart may work well for the purpose of minimizing a clearance between a piston and cylinder bore, like many specialized theoretical and experimental techniques for dimensioning machine components, its applicability may be limited depending upon the particular goals to be achieved.

### SUMMARY

In one aspect, a piston for a compression ignition internal combustion engine includes a one-piece aluminum piston body including a piston head having a combustion face defining a combustion bowl, an outer head surface having a plurality of circumferential grooves configured to receive piston rings, and defining a longitudinal axis. The piston body further includes a piston skirt adjoining the head and having first and second opposed bores formed therein, the first and second bores defining a transverse axis and being configured to receive a wrist pin for coupling the piston body with a piston rod. The skirt further includes a taper narrowing towards the head and extending from the transverse axis to one of the circumferential grooves, and the skirt defining a major diameter in a first direction normal to the longitudinal axis, and a minor diameter in a direction normal to the first direction. The major diameter has the dimensions specified for Piston 1 in Table 1, within the taper, plus or minus a tolerance of 0.014 millimeters.

In another aspect, an internal combustion engine includes an engine housing defining a plurality of cylinder bores, and having a plurality of cylinder liners positioned within the plurality of cylinder bores. The internal combustion engine further includes a plurality of pistons reciprocable within the plurality of cylinder bores, each of the plurality of pistons including a piston head and a piston skirt, and defining a longitudinal piston axis. Each of the piston skirts have first and second opposed bores formed therein and defining a transverse piston axis, the bores being configured to receive a wrist pin for coupling with a piston rod. The skirt of a first one of the pistons includes a standard taper narrowing towards the corresponding piston head and defining a standard skirt profile, and the skirt of a second one of the pistons includes a non-standard taper narrowing towards the corresponding piston head and defining a tolerance stack-up defeating skirt profile.

In still another aspect, a method of preparing a piston for returning to service in an internal combustion engine includes receiving a piston removed from service in an internal combustion engine, the piston including a piston body having a piston head and a piston skirt. The method further includes removing material from a taper located on the skirt and narrowing in the direction of the head. The method further includes shaping the taper during the step of removing material such that the taper defines a tolerance stack-up defeating profile configured to avoid scratching or scuffing the piston body against a cylinder liner when returned to service.

In still another aspect, a method of preparing a piston for service in an internal combustion engine includes receiving a piston including a piston body having a piston head and a piston skirt, and removing material from the piston body such that a taper located on the skirt narrows in the direction of the head. The method further includes shaping the taper during the step of removing material such that a major diameter of the piston within the taper has the dimensions specified for Piston 1 in Table 1, plus or minus a tolerance of 0.014 mm.

### BRIEF DESCRIPTION OF THE DRAWINGS

FIG. 1 is a sectioned side diagrammatic view of a portion of an internal combustion engine according to one embodiment;

FIG. 2 is a sectioned side diagrammatic view of a piston according to one embodiment;

FIG. 3 is another sectioned side diagrammatic view of the piston of FIG. 2;

FIG. 4 is a graph comparing a major diameter of a piston according to the present disclosure with a known piston, and including a location reference legend; and

FIG. 5 is a side diagrammatic view of a known piston removed from service in an internal combustion engine.

### DETAILED DESCRIPTION

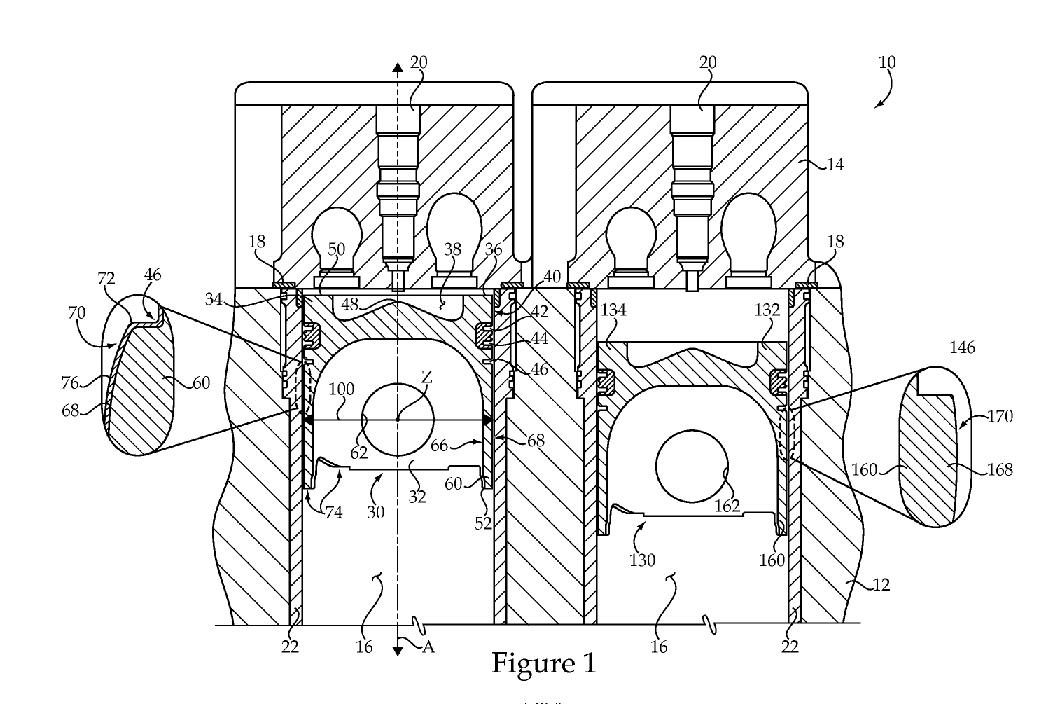

Referring to FIG. 1, there is shown an engine 10 according to one embodiment, including a housing 12 having a plurality of cylinder bores 16 formed therein. An engine head 14 is coupled with housing 12 and includes a plurality of fuel injectors 20 associated one with each of cylinder bores 16. Fuel injectors 20 may each be positioned to extend at least partially into a corresponding one of cylinder bores 16 for directly injecting a fuel therein such as a diesel distillate fuel for compression ignition in a conventional manner. A plurality of combustion seals 18 may be provided to fluidly seal between head 14 and a plurality of cylinder liners 22 positioned one within each of cylinder bores 16. While two cylinder bores are shown, engine 10 may include a greater number of cylinder bores, each equipped with a cylinder liner and fuel injector as shown in FIG. 1. A first piston 30 and a second piston 130 are shown, each reciprocable within one of cylinder bores 16. Piston 30 and piston 130 may be substantially identical in many respects, and in some embodiments in all respects, but for certain geometric characteristics relating to preventing scratching or scuffing against the corresponding cylinder liner 22, as further described herein.

To that end, the present description of piston 30 should be considered to apply generally to piston 130 except where otherwise noted. Piston 30 may include a piston body 32 including a piston head 34 having a combustion face 36 defining a combustion bowl 38. Piston head 34 may further include an outer head surface 40 having a plurality of circumferential grooves such as a top groove 42, an intermediate groove 44, and an oil groove 46. Each of grooves 42, 44, 46 is configured to receive a piston ring in a conventional manner, although the piston rings are not shown in FIG. 1 for clarity of illustration. Piston body 32 may further define a longitudinal axis A extending between a first or proximal piston end 50 and a second or distal piston end 52. In one practical implementation strategy, piston body 32 may be a one-piece aluminum piston body, and cylinder liners 22 may be formed of cast iron. As noted above, it has been observed that the combination of an aluminum piston and a cast iron cylinder liner in certain engines may be associated with scratching, scuffing and the like, particularly during breaking in the engine. The present disclosure reflects the discovery of the root causes of such phenomena, and development of practical preemptive solutions, as further described herein.

Piston body 32 may further include a piston skirt 60 adjoining head 34 and extending downwardly, or distally, from head 34. In particular, piston skirt 60 may be understood as the portion of piston body 32 which extends from oil groove 46 to, and inclusive of, second end 52. A distal end surface 74 of skirt 60 may be located at second end 52 and defines a surface contour which is non-uniform relative to longitudinal axis A. In other embodiments, the surface contour might be different from that shown. In an analogous manner, while the plurality of circumferential grooves 42, 44, 46 includes a total of three circumferential grooves in the illustrated embodiment, in other versions a different number of circumferential grooves might be used. Combustion bowl 38 is shown having a convex center peak 48 and may define a bowl volume between about 75 cm³ and about 125 cm³, but these and other features of combustion bowl 38 and combustion face 36 might also be varied without departing from the scope of the present disclosure.

Piston skirt 60 may further include first and second opposed bores 62 formed therein, one of which is shown in FIG. 1. Bores 62 may define a transverse axis Z and are configured to receive a wrist pin for coupling piston body 32 with a piston rod in a conventional manner. Skirt 60 may also include an inner skirt surface 66 and an outer skirt surface 68. Dimensioning and tolerancing of portions of skirt 60 can assist in preventing the scratching and scuffing phenomena mentioned above during break-in of engine 10, as further explained herein.

To this end, skirt 60 may further include a taper 70 shown in the leftmost detailed enlargement in FIG. 1. Taper 70 narrows towards head 34, in a proximal direction, and extends from transverse axis Z to circumferential groove 46. Piston 130 may also include a one-piece aluminum piston body 132 having a piston head 134 and a skirt 160. Piston 130 may also include a taper 170 located on skirt 160 narrowing towards head 134 and also extending from a transverse axis defined analogously to piston 30 to a circumferential groove 146, as shown in the rightmost detailed enlargement of FIG. 1. It has been discovered that the specific dimensions and shape of a piston skirt taper can impact the likelihood of scratching or scuffing occurring during breaking in an associated internal combustion engine. Accordingly, taper 70 may differ from taper 170.

The two detailed enlargements shown in FIG. 1 illustrate differences between pistons 30 and 130 with respect to features of the respective tapers 70 and 170. While somewhat exaggerated for illustrative purposes, it may be noted that taper 70 defines a skirt profile of piston 30 which is slimmer than a corresponding skirt profile of piston 130. In addition to defining a slimmer skirt profile, taper 70 arcs somewhat more acutely than taper 170. Stated another way, taper 70 may be sharper than taper 170. By constructing and/or modifying pistons according to the dimensioning and tolerancing information further discussed herein, a skirt profile configured to prevent scratching, scuffing or related phenomena, may be produced in either new or remanufactured pistons. Another feature of piston 30 differing from piston 130 shown in FIG. 1 is a graphite skirt coating 76 located on outer skirt surface 68 and extending from distal end surface 74 to circumferential groove 46. Graphite skirt coating 76 may be formed by applying a suitable graphite containing coating material such as Grafal®, at a thickness of 0.020 mm, plus or minus a tolerance of 0.007 mm. In other instances, application of graphite skirt coating 76 might be omitted. The dimensions discussed herein refer to dimensions of piston 30 and other pistons according to the present disclosure prior to applying a graphite skirt coating, if such is to be done.

Those skilled in the art will be familiar with the terms “major diameter” and “minor diameter” used in connection with pistons. In the case of piston 30, skirt 60 defines a major diameter 100, which is a dimension extending in a first direction normal to longitudinal axis A, and also normal to transverse axis Z. Skirt 60 further defines a minor diameter which extends normal to the first direction and is thus in a plane shared with axis Z in FIG. 1. In the present context, the term “normal” does not necessarily mean perfectly perpendicular, but presumes some tolerance. In a practical implementation strategy, major diameter 100 may be oriented 90° plus or minus a tolerance of 3° from transverse axis Z. Since the major diameter may be greater than the minor diameter, when viewed end-on certain portions of piston 30 can be understood as defining an oval shape, at least in terms of the path through space defined by outer skirt surface 68 within skirt 60, including within taper 70. Those skilled in the art will also readily appreciate that the ovality would typically not be perceptible to the human eye. Likewise, the differences between taper 70 and 170 would likely not be perceptible to the human eye. Features such as the major diameter within taper 70, and the sharpness or steepness of the profile defined by taper 70, will nevertheless be observably different from corresponding features of taper 170 with the use of a micrometer or other precision measurement tools. Over time, the difference in performance of pistons made according to the present disclosure versus conventionally dimensioned and toleranced pistons may indeed be perceptible to the human eye, as will be further apparent from the following description.

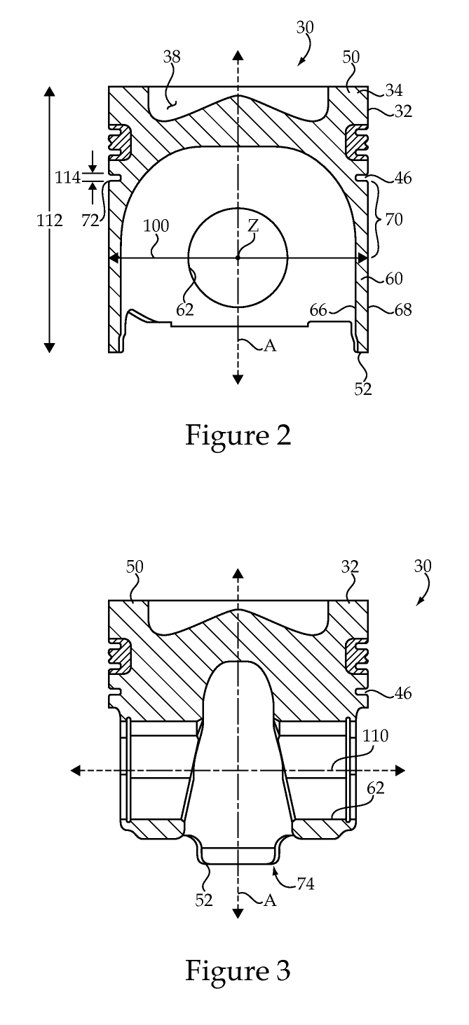

As alluded to above, major diameter 100 may serve as a design benchmark for making, repairing or remanufacturing a piston according to the present disclosure. Referring also now to FIGS. 2 and 3, there are shown two different views of piston 30 which, in conjunction with the following description, will serve to further explain features of piston 30 which contribute to improved performance over conventional designs. In FIG. 2, a piston height 112 is shown extending from first end 50 to second end 52. Piston height 112 may be equal to about 140 mm in one practical implementation strategy. A groove height 114 of circumferential groove 46 is also shown, and may be equal to about 3 mm. In one particular embodiment, groove height 114 may be equal to 3.19 mm plus or minus a tolerance of 0.01 mm. As used herein, the term “about” may be understood in the context of a number of significant digits. Accordingly, about 140 mm means between 135 mm and 144 mm. Where the term about is not used in connection with a dimensional quantity, the provided tolerance will serve as a guide in determining how much deviation from the dimensional quantity is allowable. In FIG. 2, major diameter 100 is located in the plane of the page, whereas the minor diameter extends in and out of the page and defines a line normal to the plane of the page, as in FIG. 1. In FIG. 3 the minor diameter is shown with reference numeral 110.

Major diameter 100 is shown in FIG. 2 intersecting transverse axis Z and longitudinal axis A at a common point. The location of transverse axis Z shown in FIG. 2 may be understood as a first location lying in a first plane defined by transverse axis Z and oriented normal to longitudinal axis A. Due to taper 70, moving a point of measurement of major diameter 100 in a proximal direction towards first end 50 yields different measurements. Taper 70 may be understood to extend from the first location to a second location lying in a second plane defined by an adjoinment 72 of skirt 60 and head 34. This second location may be understood to lie at a point where skirt 60 and head 34 intersect, and a specific illustration of this second location for purposes of understanding the dimensioning and tolerancing information herein is discussed below. In one embodiment, a linear distance from the first location to the second location, parallel longitudinal axis A, is equal to 39.5 mm plus or minus a tolerance of 0.5 mm. This may be understood to mean that taper 70 may shift vertically up or down relative to axis A a distance of 0.5 mm at least in certain embodiments.

The following Table 1 sets forth dimensions of the major diameter for a piston according to the present disclosure, as would be obtained when the piston is at about 68° Fahrenheit. Dimensions of the major diameter for the piston according to the present disclosure are shown in the third column from the left in Table 1 for “Piston 1.” With respect to features of taper 70, Piston 1 and piston 30 may be assumed to be the same. The major diameter dimensions are listed for a plurality of measurement points or “height locations” proceeding in a proximal direction from transverse axis Z, and a plurality of height locations proceeding in a distal direction from transverse axis Z. In Table 1, the zero height location is the location of transverse axis Z. Hence, seventeen dimensions of the major diameter at seventeen locations proceeding from transverse axis Z to approximately the combustion face are shown with positive numbers, and nine locations proceeding in the distal direction from transverse axis Z to approximately the skirt end surface are shown with negative numbers. In the fourth column from the left in Table 1, dimensions at each of the same height locations of a minor diameter for Piston 1 are shown. In the first column of Table 1, six different location references 300, 400, 500, 600, 700 and 800 are listed. From the foregoing description it will be understood that the taper extends from the zero height location to the height location at 39.50 mm, although parts of Piston 1 might actually be “tapered” distally of the zero height location or proximally of the 39.50 mm height location without departing from the scope of the present disclosure. The adjoinment 72 of skirt 60 and head 34 in piston 30 may thus be understood to lie at height location 39.50 mm.

Also shown in Table 1 in columns 5 and 6 are major diameter dimensions and minor diameter dimensions, respectively, measured at the same height locations on a known piston, Piston 2. Piston 2 might be the same as piston 130 of FIG. 1, and the cells in columns 5 and 6 which are blank in Table 1 might have dimensions which are the same as the dimensions shown in columns 3 and 4 for Piston 1. It may be noted that dimensions of the major diameter within the taper in Piston 1 are all less than the dimensions at the corresponding height locations on Piston 2. In one practical implementation strategy, a piston according to the present disclosure may include a major diameter having the dimensions specified for Piston 1 in Table 1, within the taper, plus or minus a tolerance of 0.014 mm. In a piston according to the present disclosure, the minor diameter may also include the dimensions specified for Piston 1 in Table 1, within the taper, plus or minus a tolerance of 0.025 mm. Pistons according to the present disclosure may also include all the dimensions specified for Piston 1 in Table 1, not just those within the taper.

While it might appear that the major diameter of Piston 1 within its taper is quite close to the major diameter of Piston 2 within its taper, these seemingly small differences have been discovered to yield substantially improved results, for reasons further discussed herein. It might also be speculated that manufacturing a piston having the known dimensions of Piston 2 could occasionally or accidentally have resulted in a piston within tolerance of the dimensions specified for Piston 1. This will not be the case, however. For instance, at height location 39.50 mm, the major diameter of Piston 1 is specified as 136.600 mm. Given a tolerance of plus or minus 0.014 mm, this means that the major diameter might be from 136.586 mm to 136.614 mm at the specified measurement location. If a similar tolerance is applied to the major diameter of Piston 2 at the same measurement location, the major diameter of Piston 2 will not be less than 136.706 mm, which is outside the tolerance specified for Piston 1. It will be recalled that the taper in pistons according to the present disclosure such as taper 70 may shift up or down relative to transverse axis Z within a tolerance of plus or minus 0.5 mm. While it might be possible to shift taper 70 up or down within this tolerance, and likewise shift a taper of Piston 2 up or down within a similar tolerance, the dimension of the major diameter at at least one height location within the taper of Piston 1 can always be expected to fall outside the tolerance for Piston 2. Another way to understand this principle is that Piston 1 will never have all its dimensions within tolerance of dimensions specified for Piston 2, and the differences in dimensions will be most apparent, and perhaps solely apparent, within the taper.

TABLE 1

| | | Major | Minor | Major | Minor |
|---|---|---|---|---|---|
| Location | | Diameter | Diameter | Diameter | Diameter |
| Reference | Height | Piston 1 | Piston 1 | Piston 2 | Piston 2 |
| 300 | 86.420 | 134.644 | 134.644 | | |
| | 75.072 | 134.645 | 134.645 | | |
| | 66.624 | 134.645 | 134.645 | | |
| | 63.398 | 136.22 | 136.220 | | |
| 400 | 62.220 | 136.22 | 136.220 | | |
| | 52.273 | 135.661 | 135.661 | | |
| 500 | 45.920 | 135.66 | 135.660 | | |
| | 42.685 | 135.661 | 135.661 | | |
| | 39.50 | 136.600 | 136.044 | 136.720 | 136.164 |
| | 37.42 | 136.668 | 136.116 | 136.778 | 136.225 |
| 600 | 35.43 | 136.700 | 136.150 | 136.802 | 136.252 |
| | 33.92 | 136.724 | 136.176 | 136.820 | 136.272 |
| | 30.22 | 136.760 | 136.218 | 136.842 | 136.299 |
| | 26.52 | 136.788 | 136.250 | 136.858 | 136.320 |
| | 22.82 | 136.812 | 136.280 | 136.870 | 136.337 |
| | 14.72 | 136.850 | 136.328 | 136.891 | 136.368 |
| | 6.72 | 136.874 | 136.364 | 136.908 | 136.397 |
| | 2.72 | 136.886 | 136.380 | | |
| | 0 | | | | |
| 700 | −1.15 | 136.894 | 136.394 | | |
| | −4.88 | 136.900 | 136.406 | | |
| 800 | −24.51 | 136.900 | 136.432 | | |
| | −27.08 | 136.900 | 136.436 | | |
| | −32.28 | 136.896 | 136.438 | | |
| | −38.68 | 136.890 | 136.442 | | |
| | −43.78 | 136.880 | 136.438 | | |
| | −46.78 | 136.870 | 136.432 | | |
| | −49.28 | 136.860 | 136.426 | | |

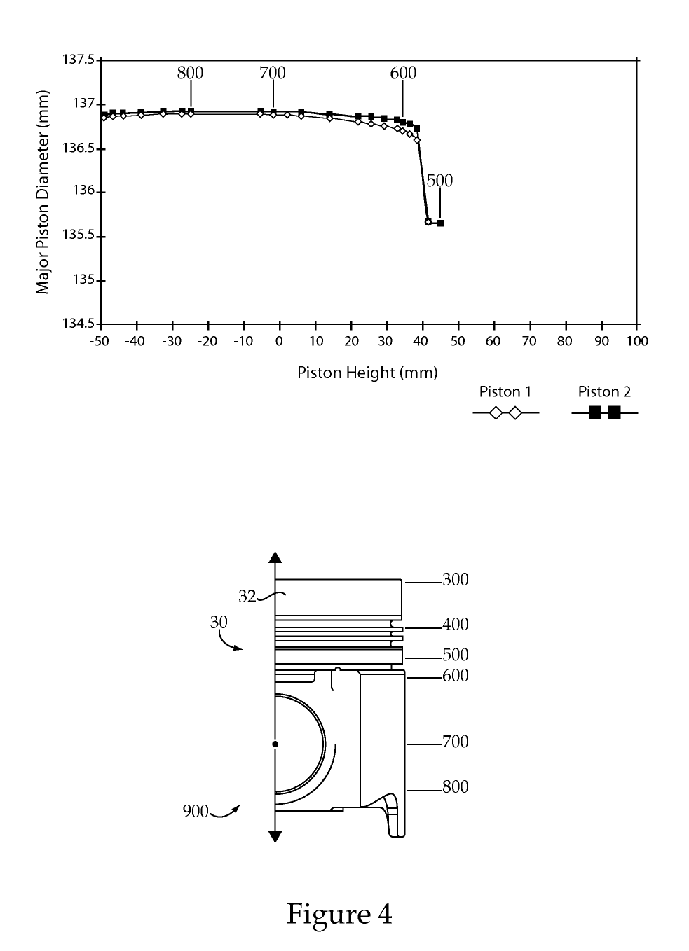

Referring now to FIG. 4, there is shown a comparison of the profiles of Piston 1 and Piston 2. Piston 2 is shown via the curve connecting square icons, and Piston 1 is shown via the curve connecting diamond shaped icons. Also shown in FIG. 4 is a legend 900 which shows a pictorial view of piston 30 where each of location references 300, 400, 500, 600, 700 and 800 are shown at their corresponding locations along piston body 32. For purposes of FIG. 4, Piston 1 and piston 30 may be assumed to be the same, and Piston 2 and piston 130 may be assumed to be the same. Certain of the location references are also shown in the graph of FIG. 4 such that the difference in the profile of Piston 2 versus Piston 1 as enumerated in Table 1 are readily apparent. As discussed above, the taper of a piston according to the present disclosure may be such that a skirt profile is relatively slimmer and sharper than a skirt profile of a known piston. The taper in pistons according to the present disclosure may also be curvilinear within a tolerance of 0.003 mm.

As also discussed above, taper 70 in piston 30 may extend from a first location within a plane defined by transverse axis Z to a second location lying in a plane defined by the adjoinment of skirt 60 and head 34. In the graph of FIG. 4 this first location would be just to the right of location reference 700 at the piston height of 0 mm. The second location lies approximately two icons to the right of location reference 600, just before the two curves begin to overlap and together plunge downward towards location reference 500. It will be readily understood that each of the squares and diamonds shown in FIG. 4 corresponds with the height locations and specified dimensions in Table 1.

### INDUSTRIAL APPLICABILITY

Those skilled in the art will be familiar with the phenomenon of tolerance stack-up. Any manufactured machine component will typically be made to some specified set of dimensions plus or minus tolerances for each of the specified dimensions. In some instances, some or all of the tolerances for one or more components may cancel one another out such that actual dimensions or clearances of interest are relatively close to theoretically perfect values. In other instances, some or all of the tolerances may be additive or subtractive such that the actual dimensions or clearances are relatively far from theoretically perfect. In the case of specified dimensions and tolerances for a piston, a cylinder liner, and clearances therebetween, additive tolerance stack-up might result in a piston having a relatively lesser clearance with the cylinder liner, whereas subtractive tolerance stack-up might result in a relatively greater clearance. Where a relatively large number of pistons and cylinder liners are manufactured, all manner of different combinations of piston dimensions and cylinder liner dimensions, within specified tolerances, can be expected. This can result in a distribution of clearances, including at least occasional assembled combinations of a piston and cylinder liner which are or become close enough to cause the scratching and/or scuffing issues noted herein. The present disclosure represents the insight that tolerance stack-up, coupled with dimensional changes in response to temperature changes during operating the engine, can ultimately result in a piston and cylinder liner interfering in a manner not expected or intended, and potentially preventing an engine from operating precisely as specified, particularly when first placed in service after manufacturing, remanufacturing, or rebuild.

As discussed above, internal combustion engines typically undergo a break-in phase where the engine is operated for some period after being placed in service. It is common for lubricant type, oil change schedules, and possibly other parameters, to be different during a break-in phase than during standard engine operation. Most of the time, operating an internal combustion engine in its break-in phase allows various components to interact with one another, deforming and moving or smoothing material and even scraping off bits of metal from one or more components until the engine reaches what is essentially a steady state of mechanical interaction among the components. When break-in is completed, wear, dimensional changes, deformation and related phenomena may cease or drop to levels not relevant to an engine's ability to operate throughout its service life or service interval. Prior to placing an engine in service, it is quite difficult if not impossible to predict whether and how components such as pistons and cylinder liners might interact with one another during the break-in phase. Experimentation and validation is often necessary where any change to established standards such as dimensions and tolerances is made. This is typically to confirm that a goal has been achieved, but also to confirm that new problems have not been created. As noted above, dimensions and tolerances tend to be relatively tightly specified in many engine systems, but nevertheless outliers at extremes may result from tolerance stack-up and cause interference. Expansion and contraction of materials in response to changes in temperature can further confound any attempt to predict whether any particular piston and cylinder liner combination will break in as intended. Even where tolerance stack-up is suspected, tracking down where the tolerance stack-up is occurring can be exceedingly difficult. Where steel or iron pistons are paired with steel or iron cylinder liners, minute interference could result in piston seizure during break-in. Where aluminum pistons are paired with cast iron cylinder liners, piston seizure is less likely, but unique problems relating to scratching and/or scuffing at least the occasional piston may occur. As mentioned above, the present disclosure represents a unique and surprising set of discoveries and solutions relating generally to these problems.

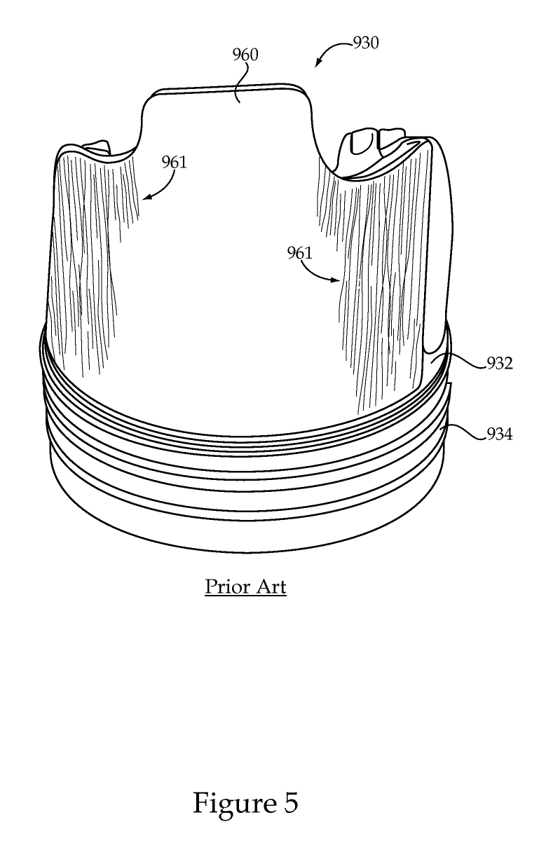

In the case of an aluminum piston paired with a cast iron cylinder liner, tolerance stack-up in one or both of the components can result in too small a clearance between the piston and cylinder liner, at least at certain locations such as an upper part of the skirt. During the break-in phase of the associated engine, scratching and scuffing of the piston can occur such that material, namely aluminum, of the piston is actually transferred to the cylinder liner. Referring to FIG. 5, there is shown a known piston 930 having a piston skirt 960 adjoining a piston head 934 in an aluminum piston body 932. Scuff marks 961 are evident, having the form of longitudinal scratches on an outer surface of skirt 960. While some variability in the location of the marks on any individual piston can certainly be expected, it has been observed that the scratches or scuff marks tend to appear on the skirt at locations plus or minus about 25° from the transverse axis of the piston, as shown. When this occurs, the intended progression of the break-in phase to a more or less steady state may never occur, and the piston and cylinder liner experiencing this phenomenon may not optimally break in. Noise resulting at least in part from contact between the components and/or blow-by of combustion gases can result in one or more cylinders of the engine which are not broken-in performing differently from other cylinders of the engine which are properly broken in.

As alluded to above, by making a piston according to the dimensions set forth for Piston 1 in Table 1 and the stated tolerances, scuffing, scratching and imperfect break-in of the piston and associated cylinder liner can be prevented. Prevention of such improper break-in results at least in part from a shape imparted to a taper such as taper 70 of the piston, either during original manufacturing, repair, or remanufacturing, which prevents interference caused by tolerance stack-up. Accordingly, the taper of a piston skirt as described herein may be understood to be such that the taper defines a tolerance stack-up defeating profile configured to avoid scuffing or scratching the piston body, in particular the piston skirt, against a cylinder liner when placed in or returned to service.

In the context of repair, remanufacturing, or rebuild an engine and/or individual pistons may be prepared for returning to service such that a piston which did not or is not breaking-in properly is modified as described herein so the piston will not scuff or scratch against the cylinder liner. Alternatively, a piston made as taught herein may be swapped for a conventional piston that did not properly break in. An engine which has been repaired, etc., in this manner may thus include a plurality of pistons which did properly break in when placed in service, and may also include one or more replacement pistons where the piston has been modified or swapped out as described herein to enable proper break-in. In such an engine, which might include engine 10 shown in FIG. 1, each of the original pistons remaining in the engine might include a skirt having a standard taper narrowing towards the corresponding piston head and defining a standard skirt profile. A second one of the pistons, which might be piston 30, could be understood to include a non-standard taper narrowing towards the corresponding piston head and defining a non-standard, tolerance stack-up defeating skirt profile configured to prevent scuffing or scratching the second one of the pistons during reciprocation within the corresponding cylinder liner during a break-in phase of the internal combustion engine.

In the case of repair, remanufacturing or rebuild, one or more pistons of an engine may be prepared for returning to service in the same or another internal combustion engine by receiving the piston after being removed from service, and removing material from an existing taper located on the skirt of the piston and narrowing in the direction of the head of the piston. During removing the material, the taper may be shaped and thus modified such that the taper defines the tolerance stack-up defeating profile configured to avoid scuffing or scratching the piston against a cylinder liner when returned to service, as discussed herein. Prior to returning the piston to service, a graphite skirt coating may be applied as also discussed herein. A similar technique may be used for preparing a new piston for service, albeit it is likely that the new piston would be machined from a casting that does not include a taper. In other words, rather than modifying an existing taper, in a new piston the taper may be formed by machining a more or less cylindrical blank.

Those skilled in the art will appreciate that developing a solution to unexpected wear, damage, stress or strain in a machine system might proceed in essentially innumerable ways. In the present context, it was unknown for literally decades what was causing scuffing or scratching of occasional pistons. Attempts at eliminating the problem could have focused on geometry of the cylinder liner, problems in manufacturing quality, or even performance and operating parameters of the engine, as well as a host of other factors. While the problem of interference among machine components is nothing new, the insight into how to solve a newly discovered tolerance stack-up problem without creating new problems in the present context is believed to be unique. It may be noted that piston skirts of the conventional as well as new pistons contemplated herein have a thinner material thickness towards their distal end. It is believed that this thinner area is less sensitive to tolerance stack-up, as the thinner area may be slightly more flexible than the thicker regions in the vicinity of the taper. Accordingly, the present insights to alter the dimensions near the taper enables the piston and engine to perform much as they did in prior designs, but without risking new problems, and while solving the scuffing and/or scratching issues which have confounded engineers for so long.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A piston for a compression ignition internal combustion engine comprising:
a one-piece aluminum piston body including a piston head having a combustion face defining a combustion bowl, an outer head surface having a plurality of circumferential grooves configured to receive piston rings, and defining a longitudinal axis;
the piston body further including a piston skirt adjoining the head and having first and second opposed bores formed therein, the first and second bores defining a transverse axis and being configured to receive a wrist pin for coupling the piston body with a piston rod;
the skirt further having a taper narrowing towards the head and extending from the transverse axis to one of the circumferential grooves, and the skirt defining a major diameter in a first direction normal to the longitudinal axis, and a minor diameter in a direction normal to the first direction; and
the major diameter having the dimensions specified for Piston 1 in Table 1, within the taper, plus or minus a tolerance of 0.014 millimeters.

2. The piston of claim 1 wherein the taper is curvilinear within a tolerance of 0.003 millimeters.

3. The piston of claim 2 wherein the major diameter is oriented 90° plus or minus a tolerance of 3° from the transverse axis.

4. The piston of claim 3 wherein the taper extends from a first location lying in a first plane defined by the transverse axis and oriented normal to the longitudinal axis to a second location lying in a second plane defined by an adjoinment of the skirt and the head, and wherein a linear distance from the first location to the second location, parallel the longitudinal axis, is equal to 39.5 millimeters plus or minus a tolerance of 0.5 millimeters.

5. The piston of claim 1 further comprising a graphite skirt coating.

6. The piston of claim 5 wherein the skirt includes a distal end surface defining a contour which is non-uniform relative to the longitudinal axis, and wherein the plurality of circumferential grooves includes a total of three circumferential grooves.

7. The piston of claim 6 wherein the minor diameter includes the dimensions specified for Piston 1 in Table 1, within the taper, plus or minus a tolerance of 0.025 mm.

8. The piston of claim 1 wherein the piston has the major diameter dimensions specified for Piston 1 in Table 1, within the taper, plus or minus a tolerance of 0.014 millimeters, at a temperature of about 68° Fahrenheit.

9. An internal combustion engine comprising:
an engine housing defining a plurality of cylinder bores, and having a plurality of cylinder liners positioned within the plurality of cylinder bores;
a plurality of pistons reciprocable within the plurality of cylinder bores, each of the plurality of pistons including a piston head and a piston skirt, and defining a longitudinal piston axis, each of the piston skirts having first and second opposed bores formed therein and defining a transverse piston axis, and being configured to receive a wrist pin therein for coupling with a piston rod;
the skirt of a first one of the pistons including a standard taper narrowing towards the corresponding piston head and defining a standard skirt profile; and
the skirt of a second one of the pistons including a non-standard taper narrowing towards the corresponding piston head and defining a tolerance stack-up defeating skirt profile.

10. The engine of claim 9 wherein each of the pistons includes a one-piece aluminum piston body, and each of the cylinder liners includes a cast iron cylinder liner.

11. The engine of claim 10 wherein the second one of the pistons includes a graphite skirt coating.

12. The engine of claim 10 wherein the tolerance stack-up defeating skirt profile is slimmer than the standard skirt profile.

13. The engine of claim 12 wherein the skirt of the second one of the pistons defines a major diameter in a first direction normal to each of the corresponding longitudinal and transverse piston axes, and a minor diameter in a second direction normal to the first direction.

14. The engine of claim 13 comprising a direct injection compression ignition engine.

15. A method of preparing a piston for returning to service in an internal combustion engine comprising the steps of:
receiving a piston removed from service in an internal combustion engine, the piston including a piston body having a piston head and a piston skirt;
removing material from a taper located on the skirt and narrowing in the direction of the head; and
shaping the taper during the step of removing material such that the taper defines a tolerance stack-up defeating profile configured to avoid scratching or scuffing the piston body against a cylinder liner when returned to service.

16. The method of claim 15 wherein the step of receiving includes receiving a piston having a one-piece aluminum piston body removed from service in a direct injection compression ignition internal combustion engine.

17. The method of claim 16 further comprising a step of applying a graphite skirt coating to the piston.

18. The method of claim 16 wherein the step of shaping further includes increasing a sharpness of the taper.

19. A method of preparing a piston for service in an internal combustion engine comprising the steps of:
receiving a piston including a piston body having a piston head and a piston skirt;
removing material from the piston body such that a taper located on the skirt narrows in the direction of the head; and
shaping the taper during the step of removing material such that a major diameter of the piston within the taper has the dimensions specified for Piston 1 in Table 1, plus or minus a tolerance of 0.014 millimeters.

20. The method of claim 19 wherein the step of receiving includes receiving a piston having a one-piece aluminum piston body removed from service in a direct injection compression ignition internal combustion engine.
